(19) United States
(12) Patent Application Publication
(10) Pub. No.: US 2025/0128376 A1
(43) Pub. Date: Apr. 24, 2025

(54) SMALL PARTS CATCHER FOR A COMPUTER NUMERICAL CONTROL MACHINE

(71) Applicant: PartNetZ LLC, Arvada, CO (US)

(72) Inventors: William Talley BATHURST, JR., Arvada, CO (US); Avelino MARTINEZ, Arvada, CO (US)

(21) Appl. No.: 18/917,531

(22) Filed: Oct. 16, 2024

Related U.S. Application Data
(60) Provisional application No. 63/591,290, filed on Oct. 18, 2023.

(51) Int. Cl. B23Q 11/00

(52) U.S. Cl. CPC B23Q 11/0067

(57) ABSTRACT

Several problems may result from finished parts falling to the bottom of a CNC machine as each part is completed. For example, the finished parts are mixed with scrap shavings and machine coolant and must be manually separated from the scrap shavings. The manual separation process exposes an operator to the scrap shavings and the machine coolant. This problem is emphasized when the finished part is particularly small or delicate. Specifically, small, finished parts may be more difficult to manually distinguish from the scrap shavings. The presently disclosed small parts catcher is intended to be a simple, low-cost device, attachable to a CNC lathe turret, particularly to a cut-off tool, to catch small parts as they are severed from a workpiece.

### CROSS-REFERENCE TO RELATED APPLICATIONS

The present application claims benefit of priority to U.S. Provisional Patent Application No. 63/591,290, entitled “Small Parts Catcher for CNC Machine,” and filed on Oct. 18, 2023, which is specifically incorporated by reference herein for all that it discloses or teaches.

### BACKGROUND

Numerical control (or computer numerical control, abbreviated CNC) is the automated control of machining tools (e.g., drills, lathes, mills, grinders, routers, and 3D printers) using a computer. A CNC machine processes a workpiece (e.g., a piece of metal, plastic, wood, ceramic, stone, or composite) to meet pre-determined specifications by following coded programmed instructions and without a human operator directly controlling the machining operations. The CNC machine includes a motorized maneuverable tool and/or platform that is controlled by a computer according to specific input instructions. The instructions are delivered to the CNC machine in the form of a sequential program of machine control instructions such as G-code or M-code, and then executed to produce one or more parts from the workpiece.

CNC offers greatly increased productivity over non-computerized machining for repetitive production, where the CNC machine is manually controlled (e.g., using devices such as hand wheels or levers) or mechanically controlled by prefabricated pattern guides. In modern CNC systems, the design of a mechanical part and its manufacturing program are highly automated. As a result, CNC machines are often left unattended or are only periodically attended as the CNC machine produces parts from the workpiece.

### SUMMARY

Implementations of the presently disclosed technology described in detail herein include a small parts catcher for a computer numerical control (CNC) machine. The small parts catcher comprises a mounting bracket to removably attach the small parts catcher to a cutoff tool extending from the CNC machine, a main body, and a catch basket removably attached to the main body. The main body includes a working volume where parts are severed from a workpiece using the cutoff tool, a tool window into the working volume to receive a working end of the cutoff tool within the small parts catcher, and a workpiece window into the working volume to receive a working end of the workpiece within the small parts catcher. The catch basket receives parts severed from the workpiece via gravity.

Implementations of the presently disclosed technology described in detail herein further include a method of using a small parts catcher to receive parts severed from a workpiece using a cutoff tool. The method comprises attaching the small parts catcher to the cutoff tool extending from a CNC machine using a mounting bracket; positioning the small parts catcher so that: a working end of the cutoff tool projects through a tool window to a working volume within a main body of the small parts catcher where parts are severed from a workpiece using the cutoff tool; and a working end of the workpiece projects through a workpiece window to meet the working end of the cutoff tool within the working volume; cutting a series of parts from the workpiece using the cutoff tool; and receiving the parts severed from the workpiece into a catch basket removably attached to the main body.

### BRIEF DESCRIPTION OF DRAWINGS

FIG. 1 illustrates an example computer numerical control (CNC) machine including a small parts catcher for a cutoff tool within the CNC machine.

FIG. 2 illustrates an example turret within a CNC machine with a cutoff tool mounted thereon, and with a small parts catcher mounted to the cutoff tool.

FIG. 3 illustrates an example cutoff tool with a small parts catcher mounted thereon.

FIGS. 4A-D illustrate several views of an example small parts catcher mounted to a cutoff tool mounting bracket.

FIG. 5A illustrates a top view of another example small parts catcher.

FIG. 5B is a section C-C of the small parts catcher of FIG. 5A.

FIGS. 6A-6B illustrate two views of an example small parts catcher having a mounting bracket enabling adjustability in three-dimensions.

FIG. 7 illustrates example operations for using a small parts catcher to collect small parts as they are separated from a workpiece.

### DETAILED DESCRIPTION

A computer numerical control (CNC) lathe is similar to a traditional lathe in that it has a rotating spindle that holds a workpiece. A toolholder holds tools that are applied to the workpiece to make desired precision cuts upon the workpiece. A CNC lathe typically has a turret which can hold between 1 and 12 tools. During operation, the turret is rotated and then moved to apply a desired tool to the workpiece at a desired location. Selection of the tool and the position of its application to the workpiece is programmed into the CNC lathe by an operator. A CNC lathe can have many tools applied sequentially to many positions on the workpiece. The last step of most machining processes is the application of a cutoff tool to the workpiece. After this step, a finished part typically falls to the bottom of the CNC lathe.

Several problems may result from the finished parts falling to the bottom of a CNC machine as each part is completed. The finished parts are mixed with scrap shavings from the workpiece and machine coolant at the bottom of the CNC machine. The finished parts must the later be manually separated from the scrap shavings, which can be time consuming and may impart some degree of part loss due to a failure of the operator to separate all finished parts from the scrap shavings. Further, the finished parts may be very small and light, particularly when machined from plastic. These parts may not be consistently directed into a conventional door mounted parts catcher. The many crevices and pockets in a CNC machine may further conceal finished parts, which can add to part loss.

The manual separation process further exposes an operator to the scrap shavings and the machine coolant. If the workpiece is metal, the scrap shavings can be sharp and cut the operator's hands as the operator separates the finished parts form the scrap shavings. Further, the finished parts, machine coolant, and the scrap shavings can be hot from the machining processes and burn the operator's hands as the operator separates the finished parts form the scrap shavings. To avoid this, the operator may attempt to catch the falling finished part by hand as they are severed from the workpiece, though this may violate various safety standards. If a CNC machine's safety provision requiring a closed and locked door is overridden, the operator risks injury due to exposure to flying scrap shavings, access to moving mechanical parts capable of causing serious physical injury, and/or risk of burn caused by the high temperature of the finished part and/or scrap shavings.

If the finished parts are retrieved while the CNC machine remains running, the operator may be endangered by moving mechanical parts of the CNC machine and flying scrap shavings as the CNC machine works to produce another finished part. Further, delicate parts may be damaged due to the fall to the bottom of the CNC machine. Still further, the operator's clothing and/or skin may become soiled when separating the finished parts form the scrap shavings.

Many of forgoing problems are emphasized when the finished part is particularly small or delicate. Specifically, small, finished parts may be more difficult to manually distinguish from the scrap shavings, which increases the part loss rate due to the failure of the operator to separate all finished parts from the scrap shavings. Small parts also require the operator to more closely scrutinize the material at the bottom of the CNC machine, which increases the operator's exposure to potential injury and the time involved to perform the separation.

The presently disclosed small parts catcher is intended to be a simple, low-cost device, attachable to a CNC lathe turret, particularly to a cut-off tool, to catch small parts as they are severed from a workpiece. In various implementations, the small parts catcher is easily installed and removed from the turret as the small parts catcher may be only put in use for some finished parts produced from the CNC machine. The presently disclosed small parts catcher may allow for an extended period of unattended operation of the CNC machine, which can enhance overall productivity.

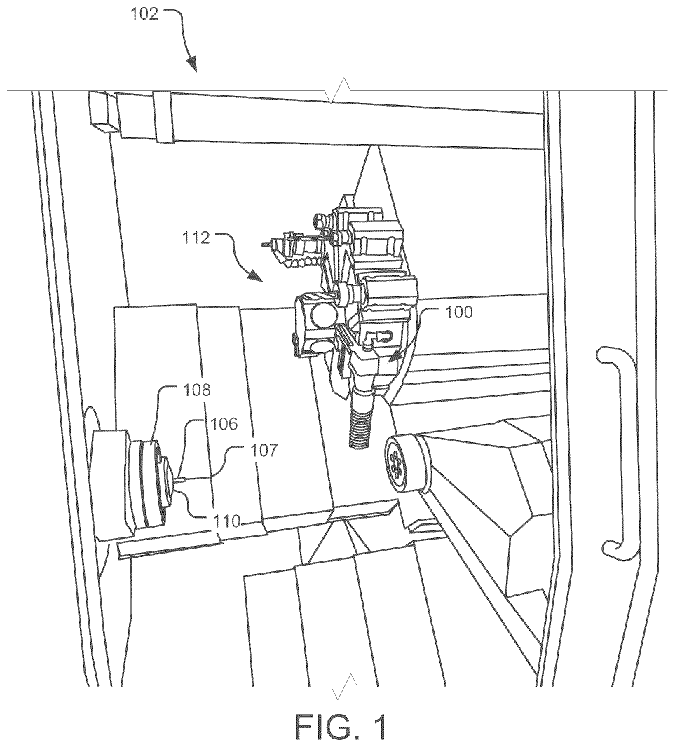

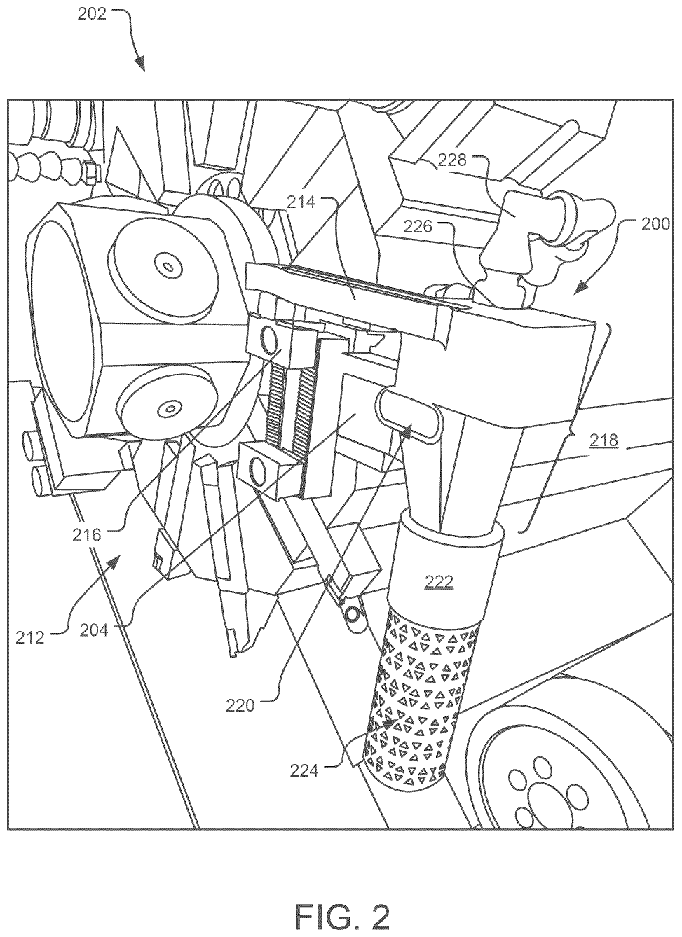

FIG. 1 illustrates an example CNC machine 102 including a small parts catcher 100 for a cutoff tool (not shown, see e.g., cutoff tool 204 of FIG. 2) within the CNC machine 102. A workpiece 106 is mounted within a spindle 108, secured by a chuck or collet 110, and mechanically rotated using the CNC machine 102 operating as any type of lathe. A working end 107 of the workpiece 106 projects out of the collet 110 toward a turret 112 of the CNC machine 102. In some implementations, the CNC machine 102 may operate multiple spindles simultaneously.

An array of tools (including, but not limited to the cutoff tool) are mounted to the turret 112 of the CNC machine 102. The turret 112 mounted tools are brought into contact with the working end 107 of the rotating workpiece 106 within the CNC machine 102 by precise tool-workpiece positioning programmed into the CNC machine 102 by an operator. As noted above, one of the tools typically mounted to the turret 112 is the cutoff tool. The last step of a series of machining operations applied to the working end 107 of the workpiece 106 to create a part is to apply the cutoff tool to the workpiece 106 in a manner that severs the part from workpiece 106 and the severed part falls away from the remaining workpiece that remains mounted within the spindle 108, typically into the bottom of the CNC machine 102. The small parts catcher 100 is intended to instead catch severed parts as they are severed from the workpiece 106 as they fall, as further described below.

FIG. 2 illustrates an example turret 212 within a CNC machine 202 with a cutoff tool 204 mounted thereon, and with a small parts catcher 200 mounted to the cutoff tool 204. An array of tools (including, but not limited to the cutoff tool 204) are mounted to the turret 212, as shown. The last step of a series of machining operations applied to a working end of the workpiece (not shown, see e.g., working end 107 of workpiece 106 of FIG. 1) to create a part is to apply the cutoff tool 204 to the workpiece in a manner that severs the part from workpiece and the severed part falls away from the remaining workpiece, typically into the bottom of the CNC machine 202. The small parts catcher 200 is intended to instead catch severed parts as they are severed from the workpiece as they fall.

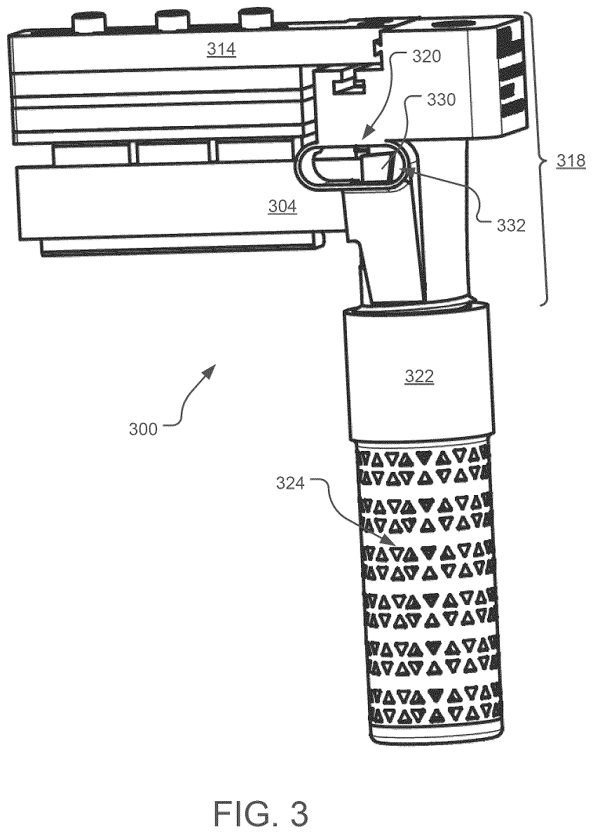

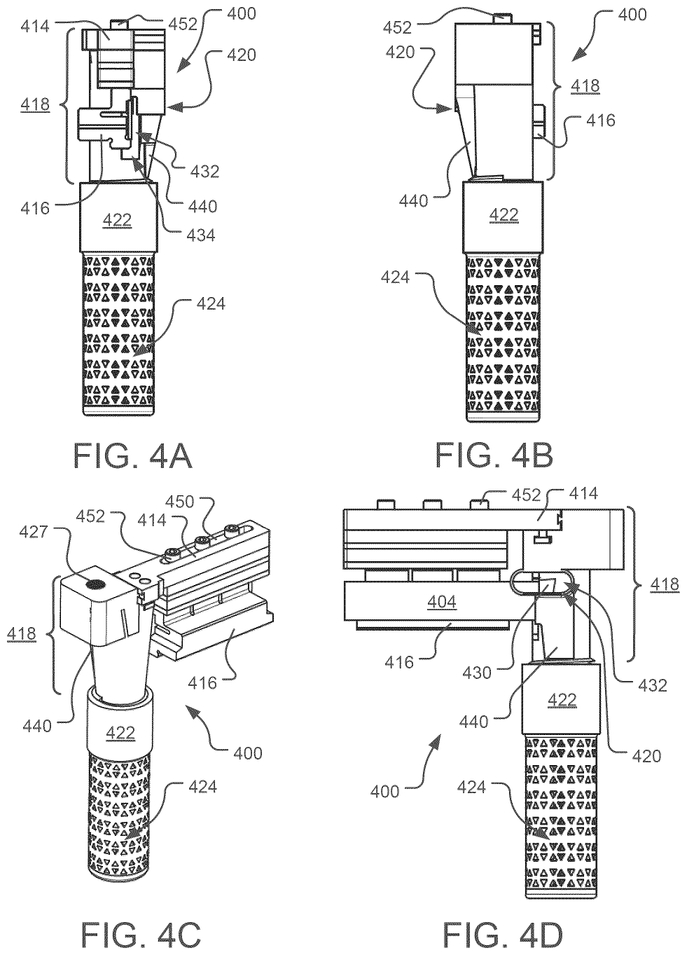

The small parts catcher 200 includes a mounting bracket 214 to removably attach the small parts catcher 200 to a portion of the cutoff tool 204 extending from the CNC machine 202. As illustrated, a separate tool bracket 216 is used to interface the cutoff tool 204 to the mounting bracket 214. The mounting bracket 214 is slotted to allow fine adjustment of the positioning of the small parts catcher 200 with reference to the cutoff tool 204. The small parts catcher 200 is positioned such that a working end (not shown, see e.g., working end 330 of FIG. 3) of the cutoff tool 204 protrudes through a tool window (not shown, see e.g., tool window 434 of FIG. 4A) in the small parts catcher 200.

The mounting bracket 214 extends from a main body 218 of the small parts catcher 200. The main body 218 includes an interior working volume (not shown, see e.g., working volume 332 of FIG. 3) where parts are severed from the workpiece using the cutoff tool 204. The tool window allows access to the working volume so that the small parts catcher 200 may receive the working end of the cutoff tool 204 within the working volume. A workpiece window 220 into the working volume allows the small parts catcher 200 to receive a working end of the workpiece within the working volume. The main body 218 further includes a coolant port 226 directed into the working volume. The coolant port 226 allows coolant to flow from fittings 228 onto the working end of the cutoff tool 204 to keep the cutoff tool 204 from overheating within the working volume. The coolant continues downward into a removable perforated basket 222.

The removable perforated basket 222 is removably attached to the main body 218 (e.g., via a screwed or snapped connection). The basket 222 receives parts severed from the workpiece via gravity. The parts are collected within the basket 222 until machining operations are complete. The operator then removes the basket 222 from the small parts catcher 200 to separate the parts from any debris within the basket 222 and collect the parts from the basket 222. The basket 222 may be solid or perforated to permit coolant to flow there though and down to a catch basin at the bottom of the CNC machine 202. The size of perforations 224 is selected to permit sufficient coolant flow through the basket 222 but are smaller than the parts severed from the workpiece so that the parts stay within the basket 222. In some implementations, the small parts catcher 200 may be coated (e.g., with a ceramic, such as Cerakote) to limit wear and prevent moisture absorption by the small parts catcher 200. Other coatings for the small parts catcher 200 are contemplated herein.

FIG. 3 illustrates an example cutoff tool 304 with a small parts catcher 300 mounted thereon. The last step of a series of machining operations applied to a workpiece (not shown, see e.g., workpiece 106 of FIG. 1) to create a part is to apply the cutoff tool 304 to a working end of the workpiece in a manner that severs the part from the workpiece and the severed part falls away from the remaining workpiece, typically into the bottom of a CNC machine (not shown, see e.g., CNC machine 102 of FIG. 1). The small parts catcher 300 is intended to instead catch severed parts as they are cut from the workpiece and fall.

The small parts catcher 300 includes a mounting bracket 314 to removably attach the small parts catcher 300 to a portion of the cutoff tool 304 extending from the CNC machine. The small parts catcher 300 is positioned such that a working end 330 of the cutoff tool 304 protrudes through a tool window (not shown, see e.g., tool window 434 of FIG. 4A) in the small parts catcher 300. The mounting bracket 314 extends from a main body 318 of the small parts catcher 300. The main body 318 includes an interior working volume 332 where parts are severed from the workpiece using the cutoff tool 304. The tool window allows access to the working volume 332 so that the small parts catcher 300 may receive the working end 330 of the cutoff tool 304 within the working volume 332. A workpiece window 320 into the working volume 332 allows the small parts catcher 300 to receive a working end of the workpiece within the working volume 332.

A removable perforated basket 322 is removably attached to the main body 318 (e.g., via a screwed or snapped connection). The basket 322 receives parts severed from the workpiece via gravity. The parts are collected within the basket 322 until machining operations are complete. The operator then removes the basket 322 from the small parts catcher 300 to separate the parts from any debris within the basket 322 and collect the parts from the basket. The basket 322 is perforated to permit coolant to flow there though and down to a catch basin at the bottom of the CNC machine. The size and shape of perforations 324 is selected to permit sufficient coolant flow through the basket 322 but small enough that the parts severed from the workpiece stay within the basket 322.

FIGS. 4A-D illustrate several views of an example small parts catcher 400 mounted to a cutoff tool mounting bracket 416. Specifically, FIG. 4A illustrates a left-side elevation view, FIG. 4B illustrates a right-side elevation view, FIG. 4C illustrates a top-rear perspective view, and FIG. 4D front elevation view of the small parts catcher 400. The last step of a series of machining operations applied to a workpiece (not shown, see e.g., workpiece 106 of FIG. 1) to create a part is to apply a cutoff tool 404 to a working end of the workpiece in a manner that severs the part from workpiece and the severed part falls away from the remaining workpiece, typically into the bottom of a CNC machine (not shown, see e.g., CNC machine 202 of FIG. 2). The small parts catcher 400 is intended to instead catch severed parts as they are cut from the working end of the workpiece as they fall.

The small parts catcher 400 includes a mounting bracket 414 to removably attach the small parts catcher 400 to a portion of the cutoff tool 404 extending from the CNC machine. A separate tool bracket 416 may be used to interface the cutoff tool 404 to the mounting bracket 414. In some implementations, the separate tool bracket 416 is omitted and the small parts catcher 400 is mounted directed to the cutoff tool 404 or a turret (not shown, see e.g., turret 212 of FIG. 2) for the CNC machine. The mounting bracket 414 is equipped with slot 450 to allow fine adjustment of the positioning of the small parts catcher 400 with reference to the cutoff tool 404. Bolts (e.g., bolt 452) extending through the bracket slot 450 secure the small parts catcher 400 to the cutoff tool 404 in a desired position. The small parts catcher 400 is positioned such that a working end 430 of the cutoff tool 404 protrudes through a tool window 434 in the small parts catcher 400.

The mounting bracket 414 extends from a main body 418 of the small parts catcher 400. The main body 418 includes an interior working volume 432 where parts are severed from the workpiece using the cutoff tool 404. The tool window 434 allows access to the working volume 432 so that the small parts catcher 400 may receive the working end 430 of the cutoff tool 404 within the working volume 432. A workpiece window 420 into the working volume 432 allows the small parts catcher 400 to receive a working end of the workpiece within the working volume 432. A chute 440 directs parts severed from the workpiece via gravity from the working volume 432 to a catch basket 422. In various implementations, the catch basket 422 is perforated and/or removable.

The main body 418 may further include a coolant port 427 directed into the working volume. In implementations where the coolant port 427 is not used, a cap (not shown) may cover the coolant port. The coolant port 427 allows coolant to flow into the working volume 432 and onto the working end 430 of the cutoff tool 404 to keep the cutoff tool 404 from overheating. The coolant continues downward into the catch basket 422. In some implementations, the coolant port 427 is omitted.

The catch basket 422 may be removably attached to the main body 418 (e.g., via a screwed or snapped connection). The catch basket 422 receives parts severed from the workpiece via gravity and the parts are collected within the catch basket 422 until machining operations are complete. The operator may then remove the catch basket 422 from the small parts catcher 400 to separate the parts from any debris within the catch basket 422 and collect the parts from the basket. The catch basket 422 may be perforated to permit coolant to flow there though and down to a catch basin at the bottom of the CNC machine. The size of perforations 424 is selected to permit sufficient coolant flow through the catch basket 422 but are smaller than the parts severed from the workpiece so that the parts stay within the catch basket 422. The small parts catcher 400 may be constructed of a variety of materials, such as metal alloys and plastics.

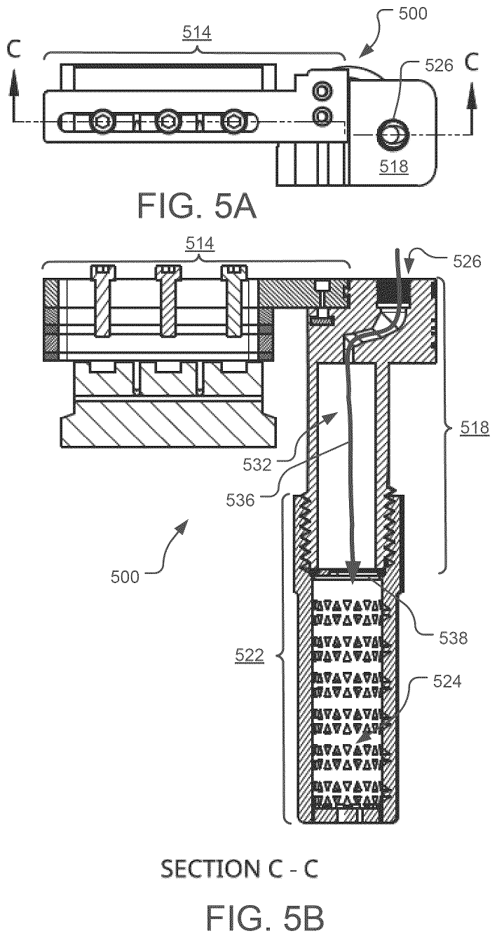

FIG. 5A illustrates a top view of another example small parts catcher 500. The last step of a series of machining operations applied to a workpiece (not shown, see e.g., workpiece 106 of FIG. 1) to create a part is to apply a working end of a cutoff tool (not shown, see e.g., cutoff tool 304 of FIG. 3) to a working end of the workpiece in a manner that severs the part from workpiece and the severed part falls away from the remaining workpiece, typically into the bottom of a CNC machine (not shown, see e.g., CNC machine 202 of FIG. 2). The small parts catcher 500 is intended to instead catch severed parts as they are cut from the workpiece as they fall.

FIG. 5B is a section C-C of the small parts catcher of FIG. 5A. The small parts catcher 500 includes a mounting bracket 514 to removably attach the small parts catcher 500 to a portion of the cutoff tool extending from the CNC machine. The mounting bracket 514 extends from a main body 518 of the small parts catcher 500. The main body 518 includes an interior working volume 532 where parts are severed from the workpiece using the cutoff tool. The main body 518 may further include a coolant port 526 directed into the working volume 532. The coolant port allows coolant to flow into the working volume 532 and onto the working end of the cutoff tool and continues downward into a catch basket 522, as illustrated by arrow 536. In various implementations, the catch basket 522 is perforated and/or removable.

The catch basket 522 is removably attached to the main body 518 (e.g., via the depicted screwed connection). The catch basket 522 receives parts severed from the workpiece via gravity and the parts are collected within the catch basket 522 until machining operations are complete. The operator may then remove the catch basket 522 from the small parts catcher 500 to separate the parts from any debris within the catch basket 522 and collect the parts from the catch basket. The catch basket 522 may be perforated to permit coolant to flow there though and down to a catch basin at the bottom of the CNC machine. The size of perforations (e.g., perforation 524) is selected so that the parts severed from the workpiece so that the parts stay within the catch basket 522.

The small parts catcher 500 may further be equipped with a check valve 538 that is secured between the main body 518 and the catch basket 522 when the small parts catcher 500 is assembled. The check valve 538 takes the form of a small flap that biases to a closed position (as depicted) that nearly matches a discharge area of the main body 518 and mostly covers the discharge area. The check valve 538 is normally closed but opened by force of coolant flowing from the coolant port, through the working volume 532, and into the catch basket 522, as illustrated by the arrow 536.

The check valve 538 opens to permit the parts severed from the workpiece to fall into the small parts catcher 500 during machining operations when the coolant is readily flowing. The check valve 538 closes after the machining operations are complete and coolant is no longer flowing through the small parts catcher 500. The parts collected in the small parts catcher 500 are better secured within the small parts catcher 500 and generally permitted from falling out of the catch basket 522 when the check valve 538 is closed. This allows the operator to remove the catch basket 522 from the small parts catcher 500 without regard to its orientation. The check valve 538 is illustrated as a component separate from both the main body 518 and compressed between the main body 518 and the catch basket 522 when assembled. In other implementations, the check valve 538 may be a part of or attached component of either the main body 518 or the catch basket 522.

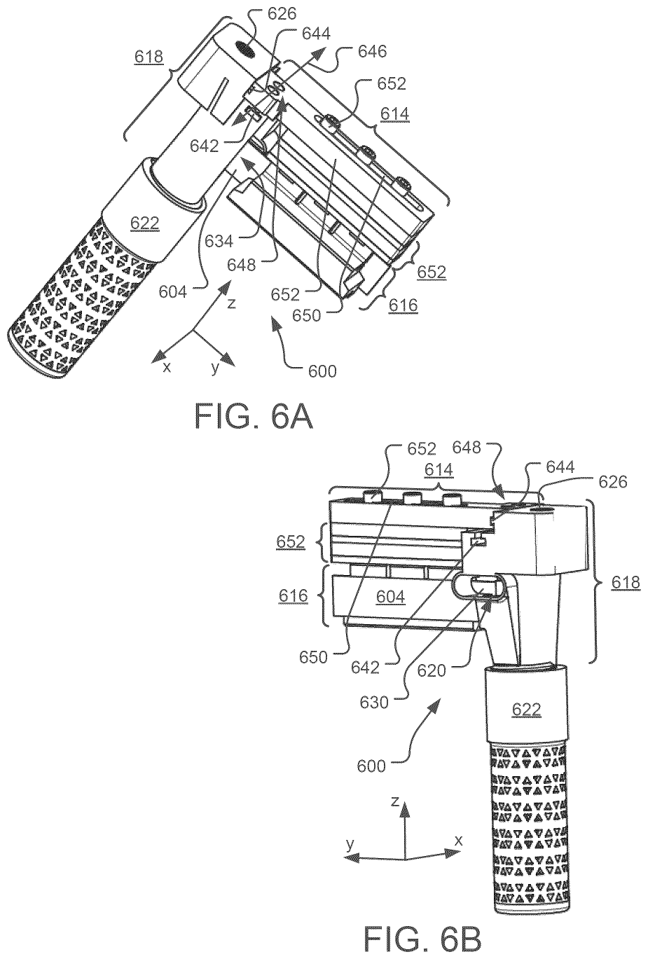

FIGS. 6A-6B illustrate two views of an example small parts catcher 600 having a mounting bracket 614 enabling adjustability in three dimensions. The small parts catcher 600 is removably attached to a portion of a cutoff tool 604 of FIG. 3) extending from a CNC machine (not shown, see e.g., CNC machine 202 of FIG. 2) via cutoff tool mounting bracket 616. The small parts catcher 600 is aligned so that a working end 630 of the cutoff tool 604 and a working end of a workpiece (not shown, see e.g., workpiece 106 of FIG. 3) converge within a working volume (not shown, see e.g., working volume 332 of FIG. 3) of the small parts catcher 600.

The mounting bracket 614 is slidably attached to a main body 618 of the small parts catcher 600. Specifically, the mounting bracket 614 and main body 618 include a first matched protrusion/T-slot 642 and a second matched protrusion/T-slot 644 to limit movement of the mounting bracket 614 with reference to the small parts catcher 600 to the depicted x-direction, as illustrated by arrow 646.

To allow precise physical positioning and alignment of the small parts catcher 600 with reference to the cutoff tool 604, the small parts catcher 600 is adjustable in each of three dimensions. The x-direction is generally aligned with the workpiece axis extending though workpiece window 620 into the working volume. For adjustment in the x-direction, the mounting bracket 614 slides with reference to the main body 618 as discussed above. Once in position, the mounting bracket 614 is then secured to the main body 618 using fasteners (e.g., T-bolts (not shown) extending from the matched protrusion/T-slot 642 through holes 648).

The y-direction is generally aligned with the cutoff tool 604 extending though tool window 634 into the working volume. The mounting bracket 614 is equipped with slot 650 to allow fine adjustment of the small parts catcher 600 in the y-direction with reference to the cutoff tool 604. Bolts (e.g., bolt 652) extend through the bracket slot 650 to secure the small parts catcher 600 to the cutoff tool 604 in a desired position in the y-direction.

Z-direction adjustments affect height of the small parts catcher 600 with reference to the cutoff tool 604. A stack of shims 652 are placed between the mounting bracket 614 and the tool bracket 616. The bolts that extend through the bracket slot 650 compress the stack of shims 652 between the mounting bracket 614 and the tool bracket 616. The height of the stack of shims 652 defines the z-direction adjustment.

The main body 618 may further include a coolant port 626 directed into the working volume. The coolant port 626 allows coolant to flow into the working volume and onto the working end 630 of the cutoff tool 604 to keep the cutoff tool 604 from overheating. The coolant continues downward into a catch basket 622. In various implementations, the catch basket 622 is perforated and/or removable. In some implementations, the coolant port is omitted.

After the small parts catcher 600 is aligned and adjusted in X-Y-Z directions, as discussed above, and secured to a turret (not shown, see e.g., turret 212 of FIG. 2) of the CNC machine, an operator proceeds to machine the workpiece with a series of machining operations. The last of the machining operations applied to the workpiece to create a part is to apply the cutoff tool 604 to the workpiece in a manner that severs the part from workpiece. The severed part falls away from the remaining workpiece, typically into the bottom of the CNC machine. The small parts catcher 600 is intended to instead catch severed parts as they are cut from the workpiece as they fall.

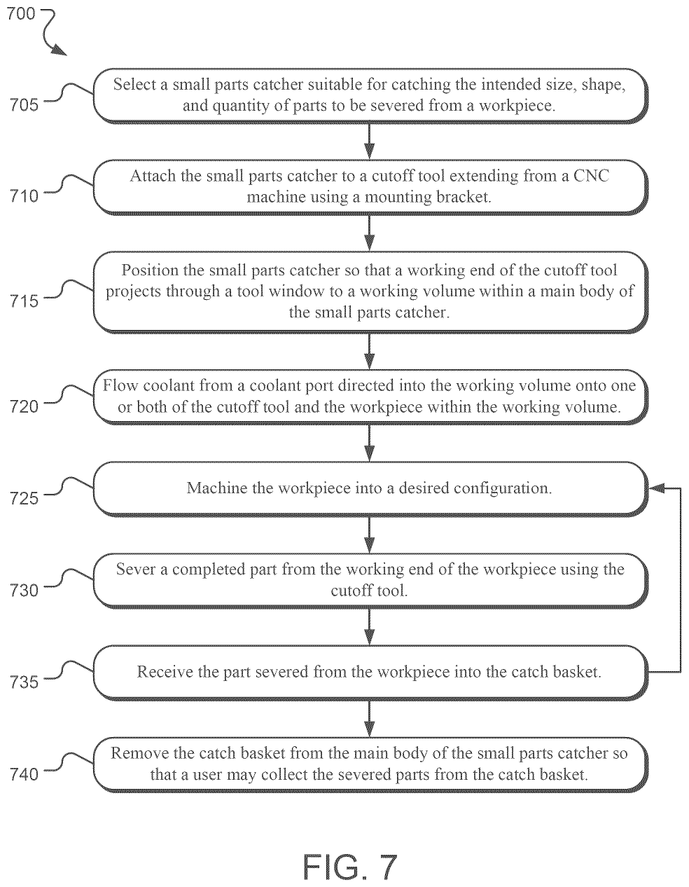

FIG. 7 illustrates example operations 700 for using a small parts catcher to collect small parts as they are severed from a workpiece extending from a spindle of a CNC machine having a tool-holding turret. A selection operation 705 selects a small parts catcher suitable for catching the intended size, shape, and quantity of parts to be severed from the workpiece. As a result, a catch basket of the small parts catcher may vary widely in size and shape to accommodate the size, shape, and quantity of parts to be severed from the workpiece.

An attaching operation 710 attaches the small parts catcher to the cutoff tool extending from a CNC machine using a mounting bracket. The mounting bracket may be slidably attached to a main body of the small parts catcher and include slots, shims, and/or other provisions for physically positioning the small parts catcher with reference to the cutoff tool in three dimensions. The small parts catcher is attached to the turret of the CNC machine such that the small parts catcher fits around the workpiece for catching the parts as they are severed from the workpiece.

A positioning operation 715 positions the small parts catcher so that a working end of the cutoff tool projects through a tool window to a working volume within a main body of the small parts catcher. The positioning operation 715 further positions the small parts catcher so that a working end of the workpiece projects through a workpiece window to meet the working end of the cutoff tool within the working volume. It is in this working volume that parts are severed from a workpiece using the cutoff tool, as discussed below. The small parts catcher is attached to the tool-holding turret such that the small parts catcher clears the CNC machine back wall when the turret is rotated about its axis into any position. The positioning operation 715 is performed using manual physical adjustments permitted by the mounting bracket.

A flowing operation 720 flows coolant from a coolant port directed into the working volume onto one or both of the cutoff tool and the workpiece within the working volume. The flowing operation 720 prevents the cutoff tool from overheating when cutting the parts from the workpiece. Perforations in the catch basket permit the coolant to flow through the catch basket and retain the parts severed from the workpiece within the catch basket. In some implementations, the flowing operation 720 causes a normally closed check valve within the small parts catcher to open by force of the coolant flowing from the coolant port, through the working volume, and into the catch basket.

Machining operations 725 machine a working end of the workpiece into a desired configuration. At the end of the machining operations 725 is a severing operation 730 that severs a completed part from the working end of the workpiece using the cutoff tool. The cutoff tool is mounted to the turret and is put in contact with the workpiece to sever the parts from the workpiece. A receiving operation 735 receives the part severed from the workpiece into the catch basket, which is removably attached to the main body. Operations 725, 730, 735 repeat to create severed parts from the workpiece and collect the severed parts in the catch basket. After the operations 725, 730, 735 are complete, a removing operation 740 removes the catch basket from the main body of the small parts catcher so that a user may collect the severed parts from the catch basket.

Logical operations making up the embodiments of the invention described herein may be referred to variously as a method, operations, method steps, objects, or modules. Further, the described logical operations may be performed in any order, adding or omitting steps as desired, unless explicitly claimed otherwise or a specific order is inherently necessitated by the claim language.

The above specification, examples, and data provide a complete description of the structure and use of exemplary implementations of the presently disclosed technology. Since many implementations of the presently disclosed technology can be made without departing from the spirit and scope of the presently disclosed technology, the presently disclosed technology resides in the claims hereinafter appended. Furthermore, structural features of the different implementations may be combined in yet other implementations without departing from the recited claims.

What is claimed is:

1. A small parts catcher for a computer numerical control (CNC) machine comprising:
a mounting bracket to removably attach the small parts catcher to a cutoff tool extending from the CNC machine;
a main body including:
a working volume where parts are severed from a workpiece using the cutoff tool;
a tool window into the working volume to receive a working end of the cutoff tool within the small parts catcher;
a workpiece window into the working volume to receive a working end of the workpiece within the small parts catcher; and
a catch basket removably attached to the main body, the catch basket to receive parts to be severed from the workpiece via gravity.

2. The small parts catcher of claim 1, wherein the catch basket is perforated with perforations smaller than the parts to be severed from the workpiece.

3. The small parts catcher of claim 2, wherein the main body further includes:
a coolant port directed into the working volume.

4. The small parts catcher of claim 3, wherein the perforations in the catch basket are to permit coolant flowing from the coolant port to flow through the catch basket and are to retain the parts severed from the workpiece within the catch basket.

5. The small parts catcher of claim 3, further comprising:
a normally closed check valve to be opened by force of coolant flowing from the coolant port, through the working volume, and into the catch basket.

6. The small parts catcher of claim 1, wherein the mounting bracket includes one or more slots that permit manual physical positioning of the small parts catcher with reference to the working end of the cutoff tool.

7. The small parts catcher of claim 1, wherein the mounting bracket permits the small parts catcher to be physically positioned with reference to the cutoff tool in three dimensions.

8. The small parts catcher of claim 1, wherein the CNC machine is a lathe, and the cutoff tool is one of an array of tools mounted to a turret within the CNC machine.

9. The small parts catcher of claim 1, constructed of a metal alloy or plastic.

10. A method of using a small parts catcher to receive parts severed from a workpiece using a cutoff tool, comprising:
attaching the small parts catcher to the cutoff tool extending from a CNC machine using a mounting bracket;
positioning the small parts catcher so that:
a working end of the cutoff tool projects through a tool window to a working volume within a main body of the small parts catcher where parts are severed from a workpiece using the cutoff tool; and
a working end of the workpiece projects through a workpiece window to meet the working end of the cutoff tool within the working volume;
cutting a series of parts from the workpiece using the cutoff tool; and
receiving the parts severed from the workpiece into a catch basket removably attached to the main body.

11. The method of claim 10, wherein the catch basket is perforated with perforations smaller than the parts to be severed from the workpiece.

12. The method of claim 11, wherein the main body further includes:
a coolant port directed into the working volume.

13. The method of claim 12, further comprising:
flowing coolant from the coolant port onto one or both of the cutoff tool and the workpiece within the working volume, wherein the perforations in the catch basket are to permit the coolant to further flow through the catch basket and retain the parts severed from the workpiece within the catch basket.

14. The method of claim 12, further comprising:
flowing coolant from the coolant port onto one or both of the cutoff tool and the workpiece within the working volume; and
opening a normally closed check valve within the small parts catcher by force of the coolant flowing from the coolant port, through the working volume, and into the catch basket.

15. The method of claim 10, wherein the mounting bracket includes one or more slots that permit manual physical positioning of the small parts catcher with reference to the working end of the cutoff tool.

16. The method of claim 10, wherein the mounting bracket permits the small parts catcher to be physically positioned with reference to the cutoff tool in three dimensions.

17. The method of claim 10, wherein the CNC machine is a lathe, and the cutoff tool is one of an array of tools mounted to a turret within the CNC machine.

18. The method of claim 10, constructed of a metal alloy or plastic.

19. A small parts catcher for a computer numerical control (CNC) machine comprising:
a mounting bracket to removably attach the small parts catcher to a cutoff tool extending from the CNC machine and physically position the small parts catcher with reference to the cutoff tool in three dimensions;
a main body including:
a working volume where parts are severed from a workpiece using the cutoff tool;
a tool window into the working volume to receive a working end of the cutoff tool within the small parts catcher;
a workpiece window into the working volume to receive a working end of the workpiece within the small parts catcher; and
a coolant port directed into the working volume; and
a perforated catch basket removably attached to the main body, the perforated catch basket to permit coolant flowing from the coolant port to flow through the perforated catch basket and retain the parts severed from the workpiece within the perforated catch basket.

20. The small parts catcher of claim 19, further comprising:
a normally closed check valve to be opened by force of coolant flowing from the coolant port, through the working volume, and into the perforated catch basket.
